(19) United States
(12) Patent Application Publication
(10) Pub. No.: US 2015/0009844 A1
(43) Pub. Date: Jan. 8, 2015

(54) Cooperation Mechanism to Lower Stand-By Power Consumption

(71) Applicants: Jarkko Kneckt, Espoo (FI); Ari Hottinen, Espoo (FI); Paivi Ruuska, Kristiansand (NO)

(72) Inventors: Jarkko Kneckt, Espoo (FI); Ari Hottinen, Espoo (FI); Paivi Ruuska, Kristiansand (NO)

(73) Assignee: Nokia Corporation, Espoo (FI)

(21) Appl. No.: 14/374,972

(22) PCT Filed: Feb. 15, 2012
(86) PCT No.: PCT/US2012/025291

§ 371 Date: Aug. 26, 2014

(51) Int. Cl. H04W 76/04; H04W 24/08

(52) U.S. Cl. CPC H04W 76/048; H04W 24/08
USPC 370/252; 370/328

(57) ABSTRACT

Methods and apparatus, including computer program products, are provided for enabling lower power consumption. In one aspect there is provided a method. The method may include establishing, by an apparatus, a first wide area network access link to a wide area network including a base station; establishing, by the apparatus, a wireless local link to at least one other apparatus; and placing the first wide area network access link on hold to allow data transmission to the wide area network to occur through the wire-less local link to the at least one other apparatus and a second wide area network access link coupling the at least one other apparatus to the wide area network. Related apparatus, systems, methods, and articles are also described.

### FIELD

The subject matter described herein relates to wireless communications.

### BACKGROUND

Cooperative multi-point (CoMP) transmissions provide cooperative communications (e.g., transmission and/or reception) among radios. For example, in a cooperative multi-point transmission, a device, such as a user equipment (UE), may transmit data via an uplink to a plurality of base stations, in which case the CoMP is referred to as uplink CoMP). The cooperative multi-point transmission may also be implemented as multiple base stations sending data via a downlink to the same receiving device, in which case the CoMP is referred to as downlink CoMP.

### SUMMARY

Methods and apparatus, including computer program products, are provided for enabling lower power consumption.

In some exemplary embodiments, there is provided a method. The method may include establishing, by an apparatus, a first wide area network access link to a wide area network including a base station; establishing, by the apparatus, a wireless local link to at least one other apparatus; and placing the first wide area network access link on hold to allow data transmission to the wide area network to occur through the wireless local link to the at least one other apparatus and a second wide area network access link coupling the at least one other apparatus to the wide area network.

In another exemplary embodiment, there is provided a method. The method may include establishing, by a wide area network, a first wide area network access link to an apparatus; placing the first wide area network access link on hold; and sending data destined for the apparatus through a second wide area network access link coupling at least one other apparatus to the wide area network and a wireless local link coupling the at least one other apparatus and the apparatus.

In some variations of some of the embodiments disclosed herein, one or more of the following may be included. Triggering may be used to place the first wide area network access link on hold, wherein the triggering is initiated by at least one of the apparatus, the wide area network, and the at least one other apparatus. One or more of a traffic load, a quality of the first wide area network access link, a quality of the second wide area network access link, and a quality of the wireless local link may be monitored to determine whether to place the first wide area network access link on hold to save power at the apparatus. The apparatus may comprise at least one of a wireless device, a user equipment, and a mobile station. The first wide area network access link may comprise at least one of an uplink to the base station and a downlink from the base station. The wireless local link may comprise a wireless link configured as at least one of a Bluetooth link and a WiFi link. Assistance may be requested from the at least one other apparatus to carry the data transmission over the second wide area network access link to the wide area network. The at least one other apparatus may use one or more parameters associated with the apparatus to communicate with the wide area network, when the wide area network is not aware of the assistance provided by the at least one other apparatus. The at least one other apparatus may use one or more other parameters associated with the at least one other apparatus to communicate with the wide area network, when the wide area network is aware of the assistance provided by the at least one other apparatus. A message may be sent to initiate a reestablishment of the first wide area network access link placed on hold. The first wide area network access link may be placed on hold by at least one of terminating the first wide area network access link, disconnecting the first wide area network access link, and reconfiguring the first wide area network access link as a maintenance control link.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIGS. 1A-1C depict block diagrams of wireless communication systems including cooperative multi-point local area networks, in accordance with some exemplary embodiments;

FIG. 2 depicts another block diagram of a wireless communication system including a cooperative multi-point local area network, in accordance with some exemplary embodiments;

FIG. 3 depicts a process for placing a wide area network access link on hold, in accordance with some exemplary embodiments;

FIGS. 4-7 depict processes for placing a wide area network access link on hold, in accordance with some exemplary embodiments;

FIGS. 8 and 9 depict processes for re-establishing a link after it has been placed on hold, in accordance with some exemplary embodiments;

FIG. 10 depicts an example of a base station, in accordance with some exemplary embodiments; and

FIG. 11 depicts an example of user equipment, in accordance with some exemplary embodiments.

Like labels are used to refer to same or similar items in the drawings.

### DETAILED DESCRIPTION

The subject matter describes herein relates to enabling cooperative transmissions among a plurality of user equipment to one or more base stations. The plurality of user equipment may establish a cooperative local area network to coordinate data transmissions to, and from, the one or more base station located in a wide area network, which in some implementations may enhance efficiency by, for example, conserving power and other resources. For example, the cooperative local area network may enable transmission of data from a first user equipment to one or more other user equipment within the cooperative local area network. The one or more other user equipment may forward the data received from the first user equipment to the base station. The one or more other user equipment act essentially as a relay, or an agent, cooperatively forwarding data to the wide area network including the base station on behalf of the first user equipment. Thus, in some exemplary embodiments, the first user equipment may save power by placing a link to the wide area network on hold, and then forwarding data to, and/or receive data from, the wide area network via another cooperative user equipment of the cooperative local area network.

In some exemplary embodiments, the cooperative local area network (which includes the first user equipment and the one or more other user equipment) may be configured in a local area network, such a wireless local area network configured in accordance with Bluetooth, WiFi, and other wireless local area network technologies. The cooperative local area network may be referred to as a local area cooperative multipoint (LA CoMP) network, in which the plurality of user equipment of the local area cooperative multipoint communicate (e.g., transmit and/or receive) with a wide area network including a base station in a cooperative manner. The use of cooperative transmissions by the user equipment, such as the above-noted first user equipment, may, in some implementations, enhance efficiency, such as throughput, save power, and the like.

In some exemplary embodiments, a user equipment may, as noted, reduce power consumption by placing its wide area network access link to a base station on hold, and, while on hold, the user equipment communicates with the wide area network including the base station using a local wireless link to another user equipment of the local area cooperative multipoint and the other user equipment's corresponding wide area access link to the wide area network/base station. For example, a local area cooperative multipoint network may include a first user equipment, which may temporarily place on hold (e.g., disconnect, power down, terminate, closed, placed in a control/maintenance mode, and the like) a wide area network access link, such as an uplink, to a base station. By placing the link to the base station on hold, the first user equipment is able to save power.

In some exemplary embodiments, the first user equipment may determine whether its wide area network access link is to be placed on hold, but in some exemplary embodiments, the wide area network and/or another user equipment may trigger the first user equipment to place its wide area network access link on hold. Moreover, the first user equipment may wake up and activate (e.g., re-connect) the link to the wide area network including the base station. For example, another user equipment of the local area cooperative multipoint network may send a so-called “wake up message” to the first user equipment, although the wake up may be initiated by other devices as well including the base station and/or the first user equipment itself.

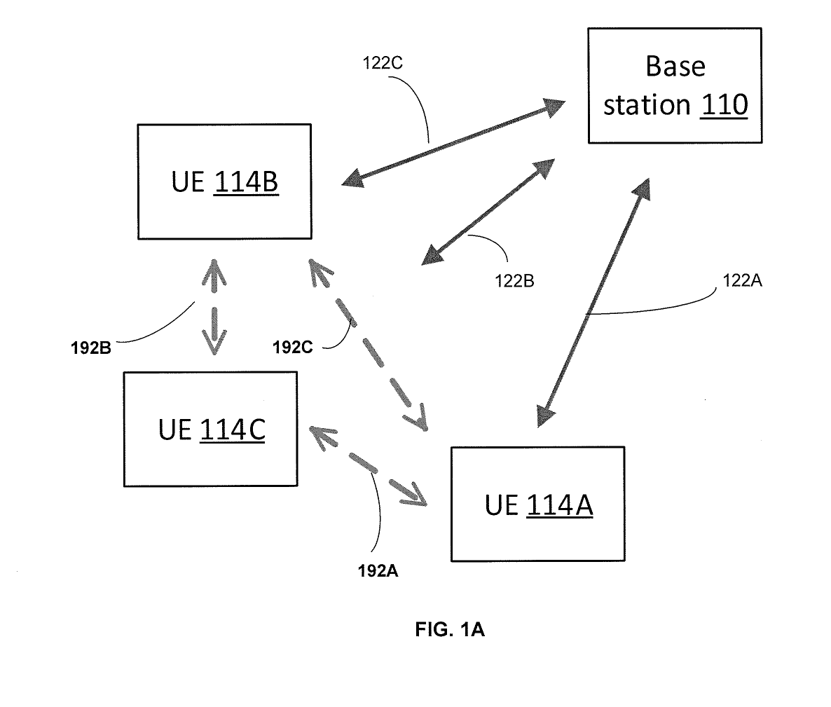

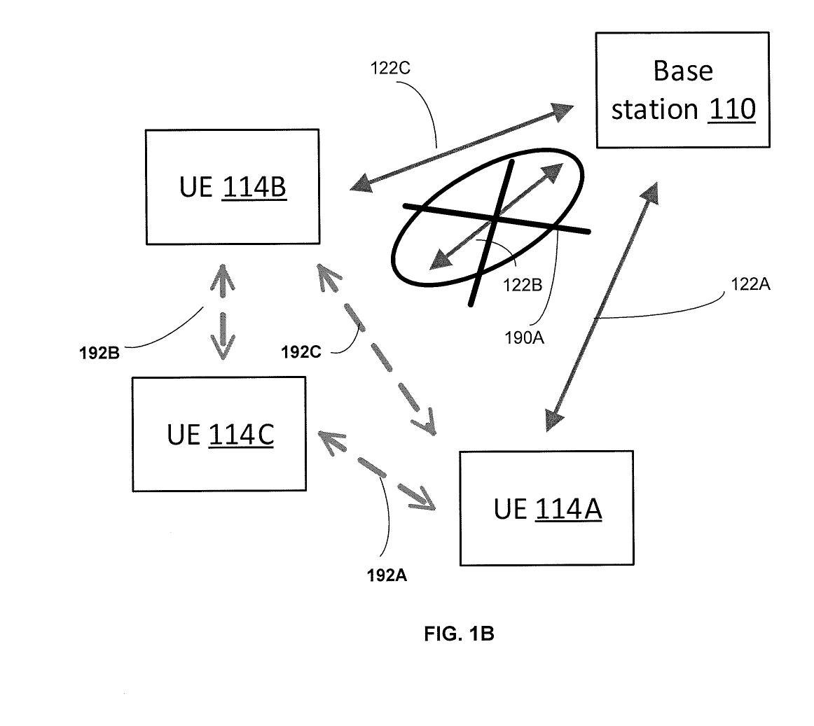

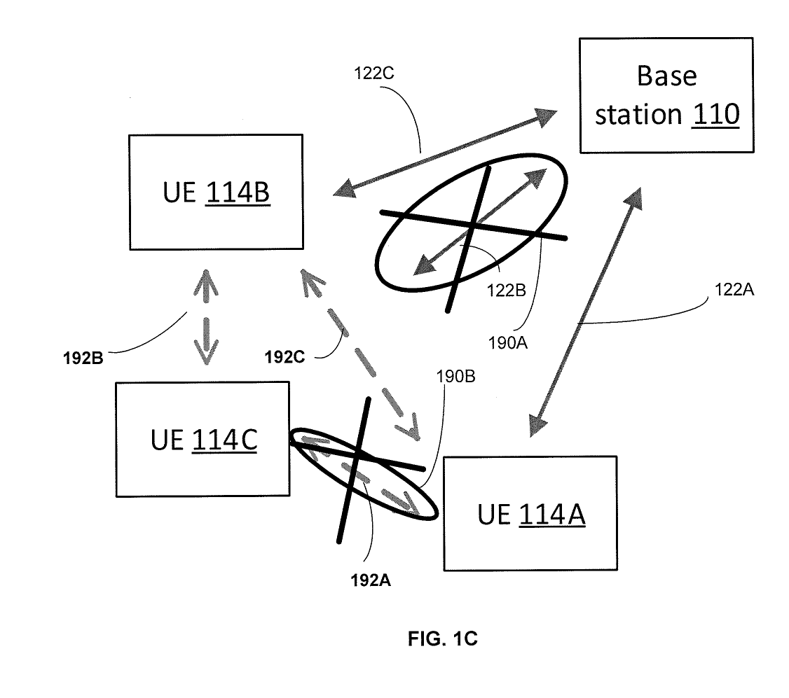

FIG. 1A depicts a system 100 including a plurality of user equipment 114A-C coupled via local wireless links 192A-C to form a local area cooperative multipoint network. System 100 also includes a base station 110 with wide area network access links 122A-C, such as uplinks, downlinks, and the like, to each of the user equipment 114A-C. As noted above, in the local area cooperative multipoint network, data from user equipment 114C may be forwarded to user equipment 114A via link 192A and/or user equipment 114B via link 192B to enable transmission to base station 110. In some exemplary embodiments, the local area cooperative multipoint network may be configured to include a plurality of wireless devices (e.g., user equipment), and one or more of these wireless devices may cooperate in communicating data to the wide area network by placing on hold one or more links to the wide area and allowing the wireless device (which has its wide area link on hold) to use another wireless device's link(s) to the wide area network/base station to send and/or receive data to and/or from the wide area network/base station.

FIG. 1B depicts system 100 after user equipment 114C temporarily places on hold link 122B to base station 110 in order to optimize power consumption (e.g., save power at user equipment 114C). FIG. 1B depicts at 190A that the link 122B to base station 110 has been temporarily places on hold, so that user equipment 114C can save power. In the example of FIG. 1B, user equipment 114C may forward any data for transmission to the wide area network to one or more other user equipment of the local area cooperative multipoint network, such as user equipment 114A and/or user equipment 114B, so that the forwarded data can be transmitted to base station 110 via links 122A and 122C. In some exemplary embodiments, the local area cooperative multipoint network (or user equipment therein) may be configured to trigger the on hold of link 122B and/or trigger a wake up to user equipment 114C to re-connect link 122B, although the trigger may be initiated by user equipment 114C itself and/or another user equipment of the local area cooperative multipoint network. Although, placing the link on hold may include disconnecting and/or terminating the link, the on hold link may also be placed into a control/maintenance mode to allow some exchange of control data to the base station but not allow user data transmission to the wide area network/base station.

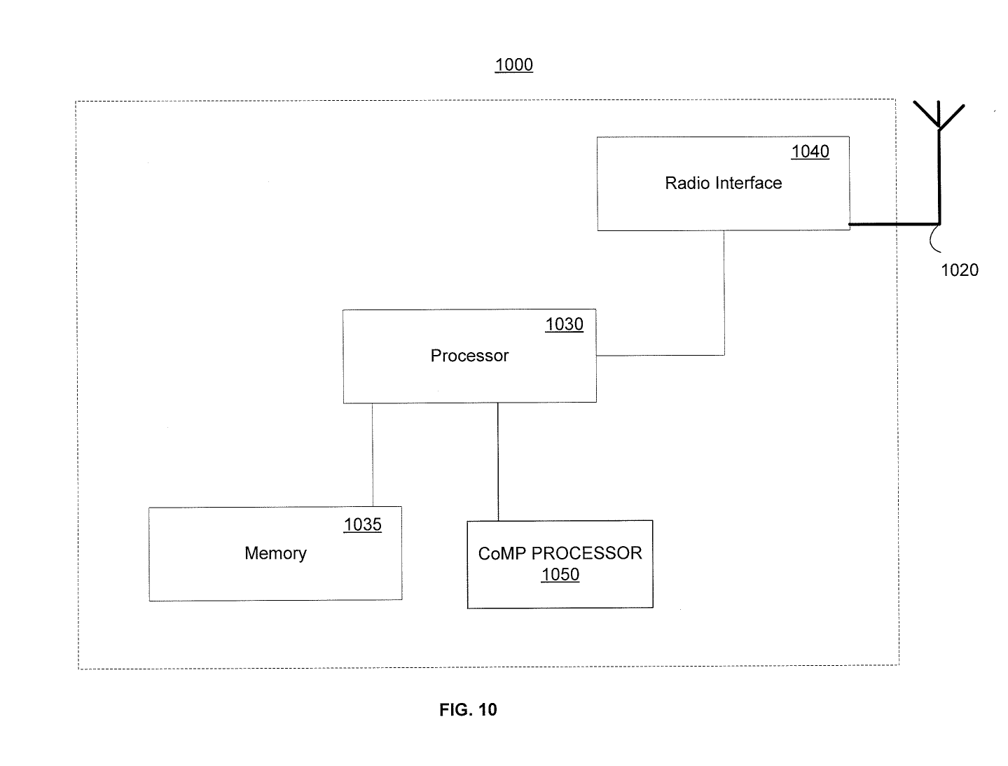

FIG. 1C depicts system 100 after user equipment 114C temporarily places on hold link 192A to user equipment 114A in order to provide additional power savings. FIG. 1C depicts at 190B that local link 192A has been temporarily placed on hold, so that user equipment 114C can save additional power. In the example of FIG. 10, user equipment 114C may forward data to user equipment 114B and wide area network access link 122C to allow transmission to wide area network/base station 110. In some exemplary embodiments, the local area cooperative multipoint network (or a user equipment therein) may be configured to trigger the temporarily disconnect 190B of local link 192A and/or trigger a wake up to user equipment 114C to re-connect link 192B, although base station 110 may also trigger the disconnect or the wake up as well. The base station may also control the configuration of the local links of the local area cooperative multipoint network.

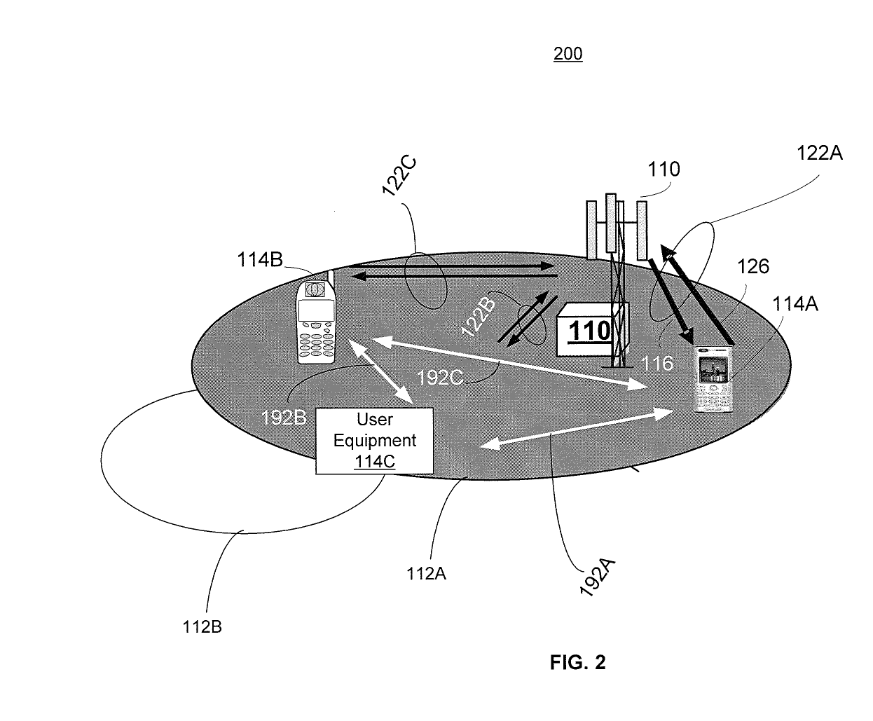

Before providing additional details, an exemplary system environment 200 is described in connection with FIG. 2. In some exemplary embodiments, the wireless communication system 200 may include base station 110 supporting corresponding service or coverage areas 112A-B (also referred to as cells). The base station 110 may be capable of communicating with wireless devices, such as user equipment 114A-C, within its coverage areas. FIG. 2 also depicts that user equipment 114C may also be in another coverage area 112B, which may be served by another base station as well. Although FIG. 2 depicts a single base station 110, two cells 112A-B, and three user equipment 114A-C, the wireless communication system 100 may include other quantities of base stations, cells, and user equipment as well.

The user equipment 114A-C may be configured in a local area network via one or more local links, such as links 192A-C. For example, links 192A-C may be implemented as Bluetooth communications links, WiFi communication links, and any other types of wireless local area network links. Moreover, user equipment 114A-C may be configured in a local area cooperative multipoint network, as noted above.

The base station 110 may, in some exemplary embodiments, be implemented as an evolved Node B (eNB) type base station consistent with standards, including the Long Term Evolution (LTE) standards, such as 3GPP TS 36.201, “Evolved Universal Terrestrial Radio Access (E-UTRA); Long Term Evolution (LTE) physical layer; General description,” 3GPP TS 36.211, “Evolved Universal Terrestrial Radio Access (E-UTRA); Physical channels and modulation,” 3GPP TS 36.212, “Evolved Universal Terrestrial Radio Access (E-UTRA); Multiplexing and channel coding,” 3GPP TS 36.213, “Evolved Universal Terrestrial Radio Access (E-UTRA); Physical layer procedures,” 3GPP TS 36.214, “Evolved Universal Terrestrial Radio Access (E-UTRA); Physical layer—Measurements,” and any subsequent additions or revisions to these and other 3GPP series of standards (collectively referred to as LTE standards).

Although FIG. 2 depicts an example of a configuration for base station 110, the base station 110 may be configured in other ways including, for example, relays, cellular base station transceiver subsystems, gateways, access points, radio frequency (RF) repeaters, frame repeaters, nodes, and include access to other networks as well. For example, base station 110 may have wired and/or wireless backhaul links to other network elements, such as other base stations, a radio network controller, a core network, a serving gateway, a mobility management entity, a serving GPRS (general packet radio service) support node, a network management system, and the like.

In some exemplary embodiments, the wireless communication system 200 may include wide area network access links, such as links 122A-C. The access links 122A-C may include a downlink, such as downlink 116, for transmitting to the user equipment 114A and/or an uplink, such as uplink 126, for transmitting from user equipment 114A to the base station 110. The downlink 116 may comprise a modulated radio frequency carrying information, such as control messages, data, and the like, to the user equipment 114A, and the uplink 126 may comprise a modulated radio frequency carrying information, such as control messages, data, and the like, from the user equipment 114A to base station 110. The downlink 116 and uplink 126 may, in some exemplary embodiments, each represent a radio frequency (RF) signal. The RF signal may, as noted above, include information, such as voice, video, images, Internet Protocol (IP) packets, control information, and any other type of data and/or messages. For example, when LTE is used, the RF signal may use OFDMA. OFDMA is a multi-user version of orthogonal frequency division multiplexing (OFDM). In OFDMA, multiple access is achieved by assigning, to individual users, groups of subcarriers (also referred to as subchannels or tones). The subcarriers are modulated using BPSK (binary phase shift keying), QPSK (quadrature phase shift keying), or QAM (quadrature amplitude modulation), and carry symbols (also referred to as OFDMA symbols) including data coded using a forward error-correction code. The subject matter described herein is not limited to application to OFDMA systems, LTE, LTE-Advanced, or to the noted standards and specifications. The uplinks and/or downlinks (which may be used as part of the wide area network access links 122A-C) may be configured in a manner similar to downlink 116 and uplink 126.

In some exemplary embodiments, the user equipment 114A-C may be implemented as a mobile device and/or a stationary device. The user equipment 114A-C are often referred to as, for example, mobile stations, mobile units, subscriber stations, wireless terminals, tablets, smart phones, smart devices, wireless devices, or the like. A user equipment may be implemented as, for example, a wireless handheld device, a wireless plug-in accessory, or the like. In some cases, user equipment may include a processor, a computer-readable storage medium (e.g., memory, storage, and the like), a radio access mechanism, and/or a user interface.

In some exemplary embodiments, a device, such as user equipment 114C, is part of a cooperative local area network and is connected to the wide area network. For example, user equipment 114C may set link 122B on hold and maintain accessibility to the wide area network through the local area cooperative multipoint network (e.g., via user equipment 114A or B and their wide area network access links).

In some exemplary embodiments, the link 122B to the wide area network (e.g., base station 110) may be set on hold without notifying the wide area network, e.g., without sending a notification message to base station 110 indicating link 122B has been placed on hold. Nor is the wide area network, such as base station 110, notified that user equipment 114C is instead using the uplinks/downlinks of other cooperative user equipment in the local area cooperative multipoint network. When the wide area network is not aware of link 122B being placed on hold, other user equipment, such as one or more of user equipment 114A-C, in the local area cooperative multipoint network may trigger (e.g., initiate) link 122B being placed on hold and thus user equipment 114C's data being sent to the other user equipment 114A or B for transmission to the wide area network/base station. However, when wide area network is aware of link 122B being placed on hold, the wide area network may trigger (e.g., initiate) link 122B being placed on hold and user equipment 114C's data being forwarded to the other user equipment 114A or B for transmission to the wide area network, although user equipment 114A-C as members of the local area cooperative multipoint network may also initiate the hold and forwarding.

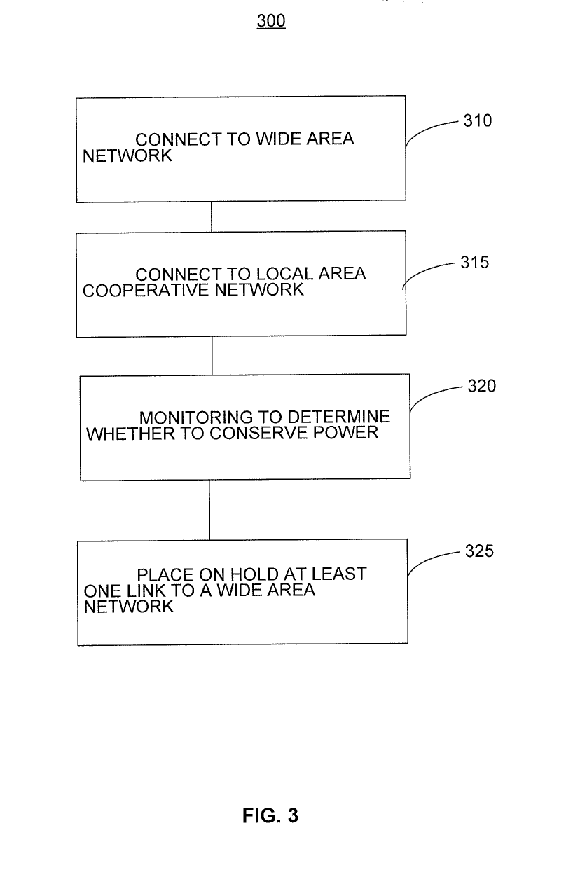

FIG. 3 depicts a process 300 for conserving power in user equipment by placing on hold a link to a wide area network and then forwarding data traffic to at least one other user equipment within a local area cooperative multipoint network, so that the at least one other user equipment can forward the data traffic to the wide area network including the base station, in accordance with some exemplary embodiments. The description of process 300 also refers to FIGS. 1A, 1B, 1C, and 2.

In some exemplary embodiments, the user equipment 114C may connect, at 310, to the wide area network including base station 110. Moreover, the user equipment 114C may also connect, at 320, to the local area cooperative multipoint network comprising user equipment 114A-C coupled via wireless local links 192A-C.

In some exemplary embodiments, monitoring may be performed at 320 to determine whether power can be saved at one of the user equipment 114A-C of the local area cooperative multipoint network. For example, user equipment 114C may monitor its traffic load, mobility, quality of wide area access network link 122B, quality of wide area access network links 122A and C, and the quality of local links 192A-B to other devices within the local area cooperative multipoint network. In some exemplary embodiments, if local area network links 192A-B are reliable, user equipment 114C may initiate an on hold of wide area network access link 122B, although the wide area network including base station 110 and/or user equipment 114A or B may also determine whether to terminate wide area access network link 122B as well. The placing on hold of wide area network access link 122B allows user equipment 114C to conserve power. Once on hold, user equipment 114C may communicate with the wide area network including base station 110 by forward traffic to, and/or receiving traffic from, other nodes, such as user equipment 114A and/or user equipment 114B of the local area multipoint cooperative network to allow those other nodes to forward/receive the traffic to a base station via their wide area network access links.

In some exemplary embodiments, one or more of user equipment 114A-C may collaboratively select which user equipment in the local area cooperative multipoint network will have one of its links configured to an on hold state. Although in some exemplary embodiments, one or more of user equipment 114A-C may instead collaboratively select a user equipment to control which links 122A-C of the local area cooperative multipoint network are placed on hold and/or triggered for a wake up.

Moreover, a variety of different rules may be used for selecting which user equipment and corresponding wide area network access links are placed on hold. For example, a rule may comprise selecting a user equipment as a controller configured to determine which user equipment in the local area cooperative multipoint network is placed on hold. Another example rule may comprise a user equipment closest to the base station (or having a high quality signal/power) being selected as the wide area network access link to be used by at least one other user equipment, which sets its wide area network access link on hold.

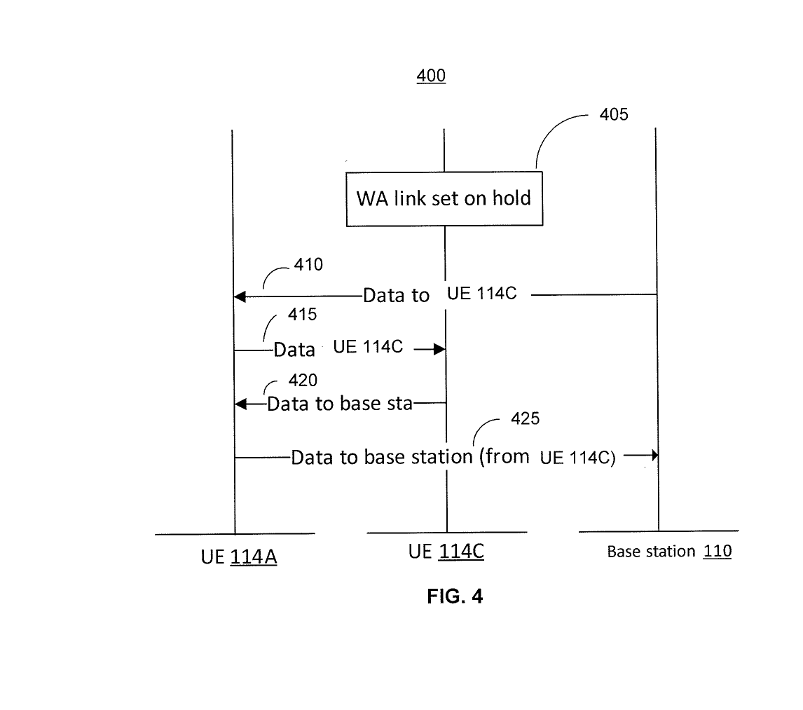

FIG. 4 depicts a process 400 for placing a wide area network access link of a user equipment on hold, in accordance with some exemplary embodiments. The description of process 400 also refers to FIGS. 1A, 1B, 1C, and 2.

When the wide area network access link 122B is on hold 405, the user equipment 114C may receive and transmit user data through another node, such as user equipment 114A or B, in the local area cooperative multipoint network. The other node, such as user equipment 114A or B acts on behalf of user equipment 114C as a relay/gateway for user equipment 114C, when communicating data to the wide area network including base station 110. For example, base station 110 may send, at 410, data to user equipment 114A, which forwards, at 415, the data via link 192A to user equipment 114C (which placed its wide area network access link 122B on hold). At 420, user equipment 114C may send data to the wide area network by first sending the data via link 192A to user equipment 114A, which forwards, at 425, the data via link 122A to base station 110.

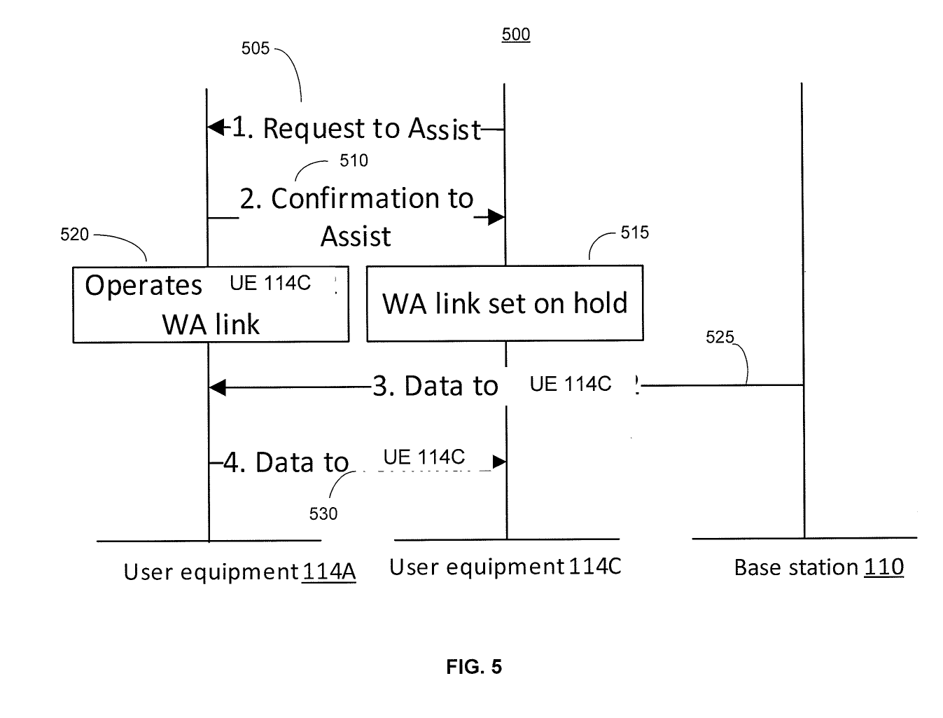

FIG. 5 depicts a process 500 for placing a wide area network access link of a user equipment on hold in accordance with some exemplary embodiments. Process 500 depicts an example process 500 used when the wide area network including base station 110 is not aware of a user equipment placing a wide area network access link on hold. The description of process 500 also refers to FIGS. 1A, 1B, 1C, and 2.

In some exemplary embodiments, user equipment 114C sends, at 505, a message requesting assistance to user equipment 114A. By sending the request for assistance message at 505, user equipment 114C attempts to save power by using another user equipment in the local area cooperative multipoint network to forward user equipment 114C's data to the wide area network/base station 110. In some exemplary embodiments, the message requesting assistance may include the wide area network access link parameters of user equipment 114C. For example, in instances when the base station 110 is not aware that user equipment 114A and/or user equipment 114B are forwarding/receiving data on behalf of user equipment 114C, user equipment 114A and/or user equipment 114B would need at least some of the security related information (e.g., security keys for authentication), link parameters, and/or the like for user equipment 114C data so that user equipment 114A and/or user equipment 114B are enabled and/or authorized to transmit data (or receive data from) the wide area network on behalf of user equipment 114C.

User equipment 114A may, at 510, confirm that it is able to relay data from user equipment 114C to the wide area network/base station 110, in accordance with some exemplary embodiments. Moreover, user equipment 114A may test user equipment 114C's wide area network access link 122B by sending test data (e.g., a null frame transmitted to base station 110 to test link 122B), and if link 122B is operative, user equipment 114A may send the confirmation at 510 to confirm the assist message. At 515, user equipment 114C may place wide area network access link 122B on hold. At 520, user equipment 114A may cooperate by allowing wide area network access link 122A to be used by user equipment 114C. As such, user equipment 114A may receive, at 525, data on behalf of user equipment 114C, and forward, at 530, any received data through the local area multipoint cooperative network to user equipment 114C. Although the previous example describes user equipment 114A receiving data on behalf of user equipment 114C, user equipment 114A may also transmit data to base station 110 on behalf of user equipment 114C.

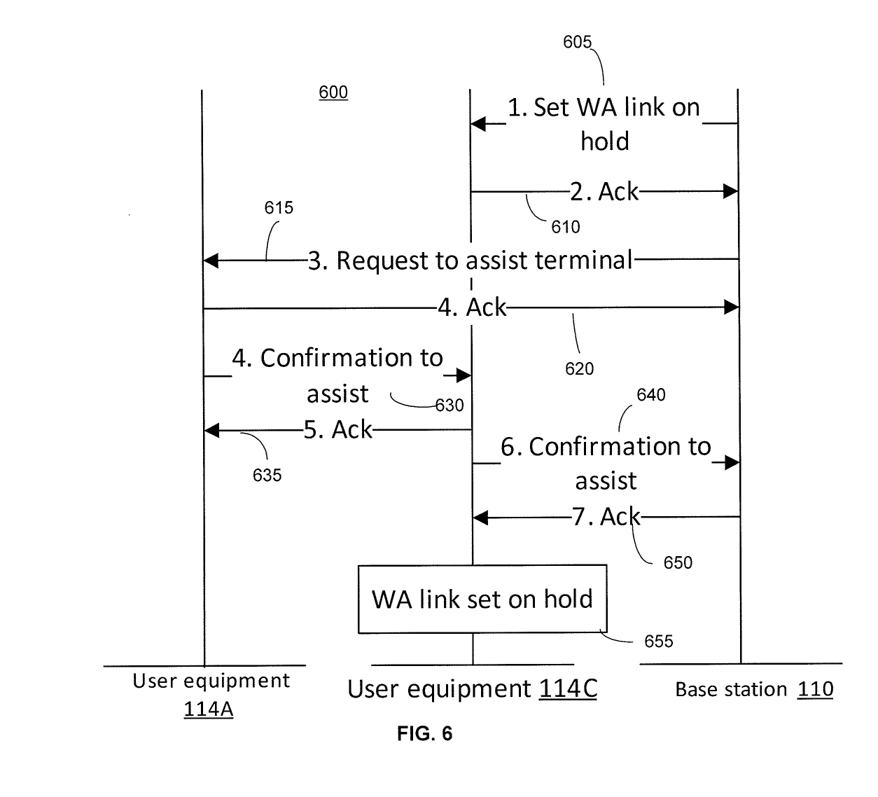

FIG. 6 depicts a process 600 for placing a wide area access link of a user equipment on hold, in accordance with some exemplary embodiments. Process 600 depicts an example process used when the wide area network, such as for example base station 110, is aware of a user equipment placing a wide area network access link on hold. The description of process 600 also refers to FIGS. 1A, 1B, 1C, and 2.

When the wide area network, such as base station 110, knows that a plurality of user equipment 114A-C belong to a local area cooperative multipoint network, the wide area network including base station 110 may determine which wide area network access link to place on hold. In some exemplary embodiments, the base station 110 may send, at 605, a message to user equipment 114C. The message may indicate that the wide area network access link 122B should be placed on hold. At 610, the user equipment 114C may respond with an acknowledgement message. At 615, base station 110 may send a request to assist message to user equipment 114A. User equipment 114A may then send an acknowledgement at 620 to base station 110 and a confirmation of assistance at 630 to user equipment 114C, which may respond with an acknowledgement at 635. User equipment 114C may also confirm with base station 110 that it will be using the wide area network access link 122A of user equipment 114A by sending a confirmation to assist message at 640. The base station 110 may acknowledge, at 650, the confirmation message sent at 640 from user equipment 114C. At 655, user equipment 114C may place its wide area access link 122B on hold, and thus receive and/or forward wide area network traffic via user equipment 114A and link 122A to base station 110.

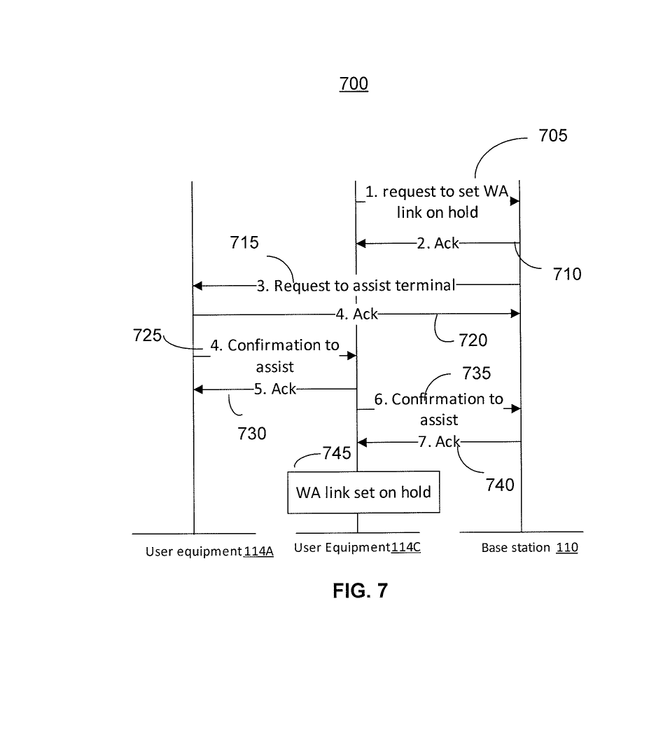

FIG. 7 depicts a process 700 for placing a wide area network access link of a user equipment on hold in accordance with some exemplary embodiments. Process 700 depicts an example process 700 used when the wide area network including base station 110 is aware of a user equipment placing a wide area network access link on hold but the link placed on hold is initiated by a user equipment of the local area cooperative multipoint network rather than the wide area network. The description of process 700 also refers to FIGS. 1A, 1B, 1C, and 2.

In some exemplary embodiments, the user equipment 114C may determine that it can save power by placing on hold (e.g., disconnecting, powering down, and the like) the wide area network access link 122B to base station 110B and instead use a wide area network access link of another user equipment on the same local area cooperative multipoint network. When this is the case, the user equipment 114C may send, at 705, a message, such as a request to set wide area network access link 122B on hold message, to base station 110. The request to set wide area network access link on hold message may include an identifier of the device, such as user equipment 114A or link 122A, which is proposed as the user equipment for forwarding/receiving user equipment's 114C traffic after link 122B. For example, user equipment 114C may leave the decision to base station 110, and base station 110 may have information identifying which user equipment 114A-C have good links to the base station 110. Base station 110 may also have information identifying that the user equipment 114A-C are in the same cooperative multipoint local area network, and which of the local links are operative as well. Furthermore, before sending message 705, user equipment 114C may measure the local area network access link that it proposes to be used for all of its transmissions. For example, user equipment 114C may measure the quality of links 192A-B.

In some exemplary embodiments, the base station 110 may, at 710, acknowledge message 705. Moreover, base station 110 may send, at 715, a request to assist message to user equipment 114A, which is the candidate user equipment being considered to assist user equipment 114C, when the link 122B is placed on hold. Moreover, the base station 110 may also configure the local area cooperative multipoint network links 192A-C. User equipment 114A may reject the request sent at 715 by sending an assistance reject message to base station 110.

In some exemplary embodiments, the request to assist message may include one or more of the following: the address or identification of user equipment 114C (which is being assisted); the wide area address of the downlink data to be forwarded to user equipment 114C; the wide area address of uplink data from the user equipment 114C; criteria to reactivate the wide area link 122B; and criteria to change the local area link 192A.

In some exemplary embodiments, user equipment 114A may send, at 720, an acknowledgement message in response to message 715. Moreover, user equipment 114A may send, at 725, a confirmation to assist message to user equipment 114C, which may send an acknowledgement at 730. In addition, user equipment 114C may send, at 735, a confirmation to assist message to base station 110, which may send an acknowledgement at 740. At 745, user equipment 114C may place wide area network access link 122B on hold to save power. During the on hold state, user equipment 114C may forward data to the wide area network via link 192A and user equipment 114A, and user equipment 114C may receive data from the wide area network via link 192A and user equipment 114A as well.

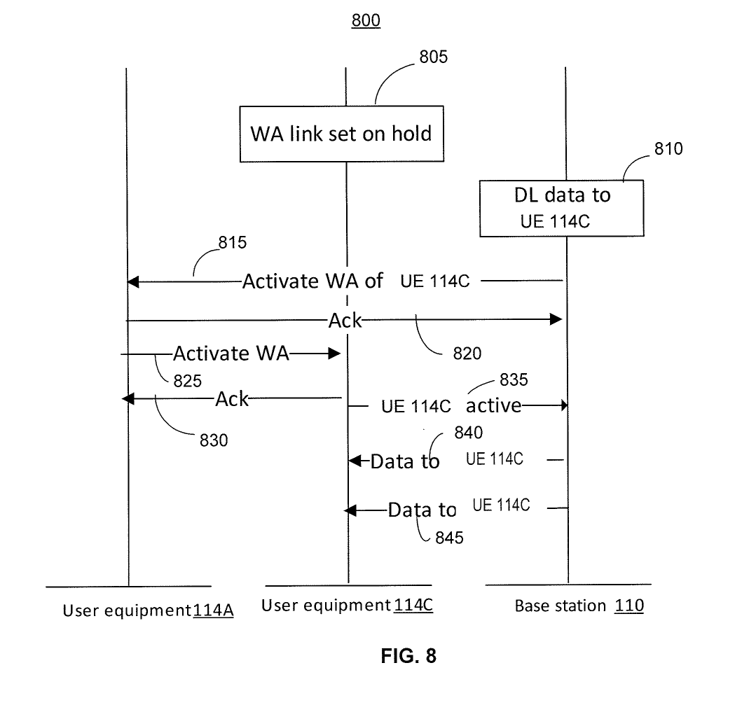

FIG. 8 depicts a process 800 for waking up a user equipment or a corresponding a wide area network access link, in accordance with some exemplary embodiments. The description of process 800 also refers to FIGS. 1A, 1B, 1C, and 2.

Process 800 depicts user equipment 114C and corresponding link 122B on hold at 805. The wake up of the on hold state may be triggered by the wide area network and/or another device in the local area cooperative multipoint network, such as user equipment 114A-C. Process 800 depicts, however, the wide area network initiating the wake up.

In some exemplary embodiments, wide area network, such as base station 110, may determine, at 810, that it seeks to establish a downlink to user equipment 114C to send data to user equipment 114C, and, as such, base station 110 may send an activate wide area network access link message to user equipment 114C at 815. The activate wide area network access link message for user equipment 114C may be forwarded via the link 122A to user equipment 114A as link 122B is on hold. The base station 110 may determine it needs to wake (e.g., initiate activation of) link 122B for a variety of reasons. For example, when link 192A or link 192B to the so-called relay node (e.g., user equipment 114A and/or 114B) degrades in quality, base station 110 may determine that link 122B should be reestablished. In some instances, base station 110 may seek to rotate the wide area network access link responsibility to another user equipment of the local area cooperative multipoint network and, as such, issue a wake message.

In some exemplary embodiments, user equipment 114A may send, at 820, an acknowledgement message to base station 110, and send at 825 an activate wide area access link message to local link 192A and user equipment 114C. User equipment 114C may acknowledge at 830 message 825, and send, at 835, a message to base station 110 to indicate that user equipment 114C and link 122B are active (and thus no longer on hold). At 840-845, the base station 110 may send data to user equipment 114C over the reestablished link 122B.

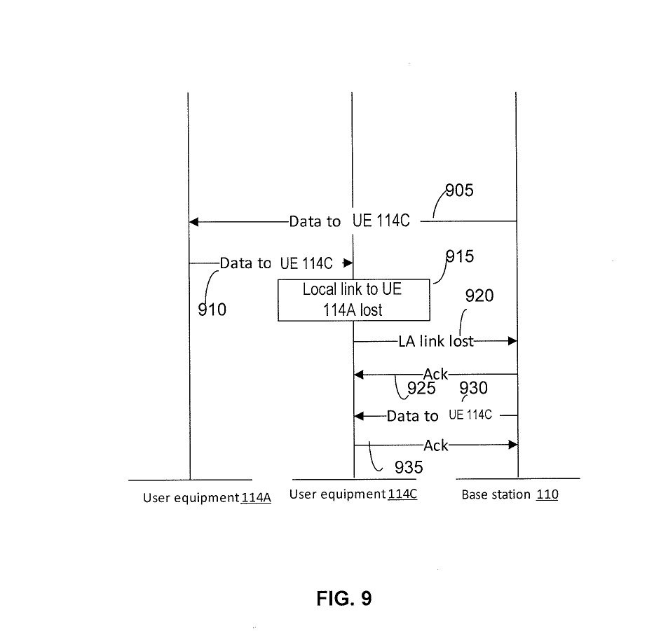

FIG. 9 depicts a process 900 for initiating a wake up of a link, in accordance with some exemplary embodiments. The description of process 900 also refers to FIGS. 1A, 1B, 1C, and 2.

In some exemplary embodiments, user equipment 114C is assisted by user equipment 114A in the sense that user equipment 114A relays (e.g., transmits and/or receives) on behalf of user equipment 114C data to the base station 110 via link 122A. At 905, base station 110 may send data to user equipment 114A, which forwards at 910 the data to user equipment 114C via local area link 192A. At 915, the local area link 192A is lost and/or unavailable. At 920, user equipment 114C may then re-establish its link 122B to base station 110 by at least sending to base station 110 a local area link lost message to indicate that local area link 192A has been lost (or is no longer accessible). At 925, the base station 110 may send an acknowledgement message responding to message 920. At 930, base station 110 may send over reestablished link 122B data directly to user equipment 114C, which may send an acknowledgement at 935.

FIG. 10 depicts an example implementation of a base station 1000, which may be implemented at base station 110. The base station may include one or more antennas 1020 configured to transmit via a downlink and configured to receive uplinks via the antenna(s) 1020. The base station may further include a radio interface 1040 coupled to the antenna 1020, a processor 1030 for controlling the base station 1000 and for accessing and executing program code stored in memory 1035. The radio interface 1040 may further include other components, such as filters, converters (e.g., digital-to-analog converters and the like), mappers, a Fast Fourier Transform (FFT) module, and the like, to generate symbols for a transmission via one or more downlinks and to receive symbols (e.g., via an uplink). In some implementations, the base station may also be compatible with IEEE 802.16, LTE, LTE-Advanced, and the like, and the RF signals of downlinks and uplinks are configured as an OFDMA signal. The base station may include a cooperative multi-point local area network processor 1050. In some implementations, the cooperative multi-point local area network processor 1050 may perform one or more of the operations described herein with respect to a base station, such as an eNB, including one or more aspects of processes 300, 400, 500, 600, 700, 800, and/or 900.

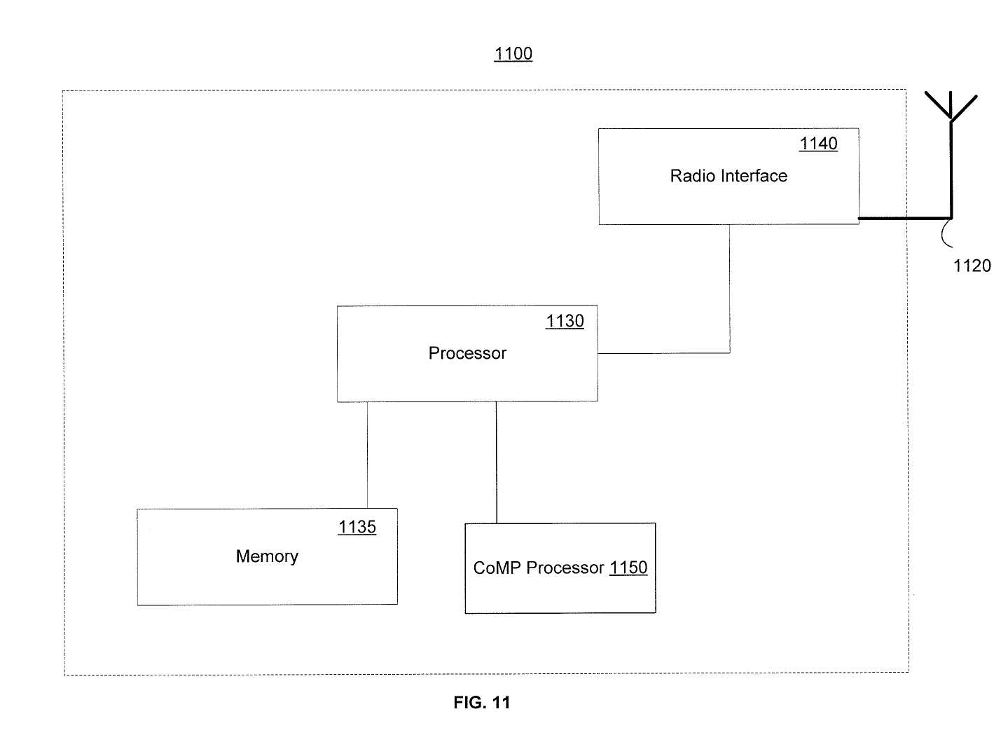

FIG. 11 depicts a block diagram of a radio, such as a user equipment 1100. The user equipment 1100 may include an antenna 1120 for receiving a downlink and transmitting via an uplink. The user equipment 1100 may also include a radio interface 1140, which may include other components, such as filters, converters (e.g., digital-to-analog converters and the like), symbol demappers, signal shaping components, an Inverse Fast Fourier Transform (IFFT) module, and the like, to process symbols, such as OFDMA symbols, carried by a downlink or an uplink. In some implementations, the user equipment 1100 may also be compatible with WiFi, Bluetooth, GERAN, UTRAN, E-UTRAN, and/or other standards and specifications as well. The user equipment 1100 may further include at least one processor, such as processor 1130, for controlling user equipment 1100 and for accessing and executing program code stored in memory 1135. The user equipment may include a cooperative multi-point local area network processor 1150. In some exemplary embodiments, cooperative multi-point local area network processor 1150 may perform one or more of the operations described herein with respect to user equipment including one or more aspects of processes 300, 400, 500, 600, 700, 800, and/or 900.

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “machine-readable medium” refers to any computer program product, computer-readable medium, computer-readable storage medium, apparatus and/or device (e.g., magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flow depicted in the accompanying figures and/or described herein does not require the particular order shown, or sequential order, to achieve desirable results. Other embodiments may be within the scope of the following claims.

1. A method comprising:
establishing, by an apparatus, a first wide area network access link to a wide area network including a base station;
establishing, by the apparatus, a wireless local link to at least one other apparatus; and
placing the first wide area network access link on hold to allow data transmission to the wide area network to occur through the wireless local link to the at least one other apparatus and a second wide area network access link coupling the at least one other apparatus to the wide area network.

2. A method as in claim 1 further comprising:
triggering the placing of the first wide area network access link on hold, wherein the triggering is initiated by at least one of the apparatus, the wide area network, and the at least one other apparatus.

3. A method as in any of claims 1 further comprising:
monitoring one or more of a traffic load, a quality of the first wide area network access link, a quality of the second wide area network access link, and a quality of the wireless local link to determine whether to place the first wide area network access link on hold to save power at the apparatus.

4. A method as in any of claims 1, wherein the apparatus comprises at least one of a wireless device, a user equipment, and a mobile station.

5. A method as in any of claims 1, wherein the first wide area network access link comprises at least one of an uplink to the base station and a downlink from the base station.

6. A method as in any of claims 1, wherein the wireless local link comprises a wireless link configured as at least one of a Bluetooth link and a WiFi link.

7. A method as in any of claims 1 further comprising:
requesting assistance from the at least one other apparatus to carry the data transmission over the second wide area network access link to the wide area network, wherein the at least one other apparatus uses one or more parameters associated with the apparatus to communicate with the wide area network, when the wide area network is not aware of the assistance provided by the at least one other apparatus, and wherein the at least one other apparatus uses one or more other parameters associated with the at least one other apparatus to communicate with the wide area network, when the wide area network is aware of the assistance provided by the at least one other apparatus.

8. A method as in any of claims 1 further comprising:
sending a message to initiate a reestablishment of the first wide area network access link placed on hold.

9. A method as in any of claims 1 further comprising:
placing the first wide area network access link placed on hold by at least one of terminating the first wide area network access link, disconnecting the first wide area network access link, and reconfiguring the first wide area network access link as a maintenance control link.

10. An apparatus comprising:
at least one processor; and
at least one memory including code which when executed configures operations comprising:
establishing, by the apparatus, a first wide area network access link to a wide area network including a base station;
establishing, by the apparatus, a wireless local link to at least one other apparatus; and
placing the first wide area network access link on hold to allow data transmission to the wide area network to occur through the wireless local link to the at least one other apparatus and a second wide area network access link coupling the at least one other apparatus to the wide area network.

11. An apparatus as in claim 10 further comprising:
triggering the placing of the first wide area network access link on hold, wherein the triggering is initiated by at least one of the apparatus, the wide area network, and the at least one other apparatus.

12. An apparatus as in any of claims 10 further comprising:
monitoring one or more of a traffic load, a quality of the first wide area network access link, a quality of the second wide area network access link, and a quality of the wireless local link to determine whether to place the first wide area network access link on hold to save power at the apparatus.

13. An apparatus as in any of claims 10, wherein the apparatus comprises at least one of a wireless device, a user equipment, and a mobile station.

14. An apparatus as in any of claims 10, wherein the first wide area network access link comprises at least one of an uplink to the base station and a downlink from the base station.

15. An apparatus as in any of claims 10, wherein the wireless local link comprises a wireless link configured as at least one of a Bluetooth link and a WiFi link.

16. An apparatus as in any of claims 10 further comprising:
requesting assistance from the at least one other apparatus to carry the data transmission over the second wide area network access link to the wide area network.

17. An apparatus as in any of claims 10 further comprising:
sending a message to initiate a reestablishment of the first wide area network access link placed on hold.

18. An apparatus as in any of claims 10 further comprising:
placing the first wide area network access link placed on hold by at least one of terminating the first wide area network access link, disconnecting the first wide area network access link, and reconfiguring the first wide area network access link as a maintenance control link.

19. A non-transitory computer readable medium including code which when executed by at least one processor provides operations comprising:
establishing, by the apparatus, a first wide area network access link to a wide area network including a base station;
establishing, by the apparatus, a wireless local link to at least one other apparatus; and
placing the first wide area network access link on hold to allow data transmission to the wide area network to occur through the wireless local link to the at least one other apparatus and a second wide area network access link coupling the at least one other apparatus to the wide area network.

20. A method comprising:
establishing, by a wide area network, a first wide area network access link to an apparatus;
placing the first wide area network access link on hold; and
sending data destined for the apparatus through a second wide area network access link coupling at least one other apparatus to the wide area network and a wireless local link coupling the at least one other apparatus and the apparatus.

21. A method as in claim 20 further comprising:
triggering the placing of the first wide area network access link on hold, wherein the triggering is initiated by at least one of the apparatus, the wide area network, and the at least one other apparatus.

22. A method as in any of claims 20 further comprising:
monitoring one or more of a traffic load, a quality of the first wide area network access link, a quality of the second wide area network access link, and a quality of the wireless local link to determine whether to place the first wide area network access link on hold to save power at the apparatus.

23. A method as in any of claims 20 further comprising:
sending a message to initiate a reestablishment of the first wide area network access link placed on hold.

24. An apparatus comprising:
at least one processor; and
at least one memory including code which when executed configures operations comprising:
establishing, by a wide area network, a first wide area network access link to an apparatus;
placing the first wide area network access link on hold; and
sending data destined for the apparatus through a second wide area network access link coupling at least one other apparatus to the wide area network and a wireless local link coupling the at least one other apparatus and the apparatus.

25. An apparatus as in claim 24 further comprising:
triggering the placing of the first wide area network access link on hold, wherein the triggering is initiated by at least one of the apparatus, the wide area network, and the at least one other apparatus.

26. An apparatus as in any of claims 24 further comprising:
monitoring one or more of a traffic load, a quality of the first wide area network access link, a quality of the second wide area network access link, and a quality of the wireless local link to determine whether to place the first wide area network access link on hold to save power at the apparatus, wherein the monitoring is performed by at least one of the apparatus, the wide area network, and the at least one other apparatus.

27. An apparatus as in any of claims 24 further comprising:
sending a message to initiate a reestablishment of the first wide area network access link placed on hold.

28. A non-transitory computer readable medium including code which when executed by at least one processor provides operations comprising:
establishing, by a wide area network, a first wide area network access link to an apparatus;
placing the first wide area network access link on hold; and
sending data destined for the apparatus through a second wide area network access link coupling at least one other apparatus to the wide area network and a wireless local link coupling the at least one other apparatus and the apparatus.
